(19) United States
(12) Patent Application Publication
(10) Pub. No.: US 2026/0163505 A1
(43) Pub. Date: Jun. 11, 2026

(54) VOICE COIL MOTOR DRIVING CIRCUIT WITH ADAPTIVE CONTROL OF THE SUPPLY VOLTAGE

(71) Applicant: SAMSUNG ELECTRO-MECHANICS CO., LTD., Suwon-si (KR)

(72) Inventor: Youn Joong LEE, Suwon-si (KR)

(73) Assignee: SAMSUNG ELECTRO-MECHANICS CO., LTD., Suwon-si (KR)

(21) Appl. No.: 19/259,178

(22) Filed: Jul. 3, 2025

(30) Foreign Application Priority Data
Dec. 6, 2024 (KR) 10-2024-0180141

(51) Int. Cl. H02P 7/025; G03B 13/36; H02M 3/158; H02P 7/29; H02P 7/292

(52) U.S. Cl. CPC H02P 7/025; G03B 13/36; H02M 3/1582; H02P 7/29; H02P 7/292

(57) ABSTRACT

A voice coil motor driving circuit is provided. The coil motor driving circuit includes a first circuit in which a first top transistor, a second top transistor, a first bottom transistor, a second bottom transistor are connected to each other by a bridge structure, and the first circuit includes a first switch, a second switch, and a voice coil motor; a second circuit including a third bottom transistor, a fourth bottom transistor, and a current source; and a power voltage control circuit respectively connected to the first circuit and the second circuit, and configured to control a power voltage of the second circuit to match a reference voltage of the first circuit based on a feedback operation, and the power voltage control circuit may be connected to a node between the switch and the second switch.

### CROSS-REFERENCE TO RELATED APPLICATIONS

This application claims the benefit under 35 USC § 119 (a) of Korean Patent Application No. 10-2024-0180141 filed on Dec. 6, 2024, in the Korean Intellectual Property Office, the entire disclosure of which is incorporated herein by reference for all purposes.

### BACKGROUND

### 1. Field

The following description relates to a voice coil motor driving circuit with adaptive control of the supply voltage.

### 2. Description of Related Art

As the performance of smartphone camera modules increases, the weight of optical systems such as lenses and prisms also increases. However, in order to drive such relatively heavy optical systems to perform autofocusing (AF) or optical image stabilization (OIS) operations, an increase in driving power is desired.

However, since a power voltage of a driver integrated circuit (IC) for driving a voice coil motor for AF or OIS operations is generally limited to a maximum of 3.3 V, attempts may be made to increase the number of coils or reduce an air gap to secure driving power. However, in this case, there may be a risk of problems such as difficulty in miniaturizing a camera module and reduced mass production yield.

Additionally, a constant error value occurs in the coil driving current due to the offset characteristics of the driver IC for driving a voice coil motor, which may make it difficult to precisely control the voice coil motor and may cause driving noise.

Accordingly, there is demand for a circuit that drives a voice coil motor that minimizes the offset characteristics and increases a maximum value of a driving current to secure a high driving power.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a voice coil motor driving circuit includes a first circuit in which a first top transistor, a second top transistor, a first bottom transistor, and a second bottom transistor are connected to each other by a bridge structure, and the first circuit further comprises a first switch, a second switch, and a voice coil motor; a second circuit comprising a third bottom transistor, a fourth bottom transistor, and a current source; and a power voltage control circuit respectively connected to the first circuit and the second circuit, and configured to control a power voltage of the second circuit to match a reference voltage of the first circuit based on a feedback operation, wherein the power voltage control circuit is connected to a node between the first switch and the second switch.

The power voltage control circuit may be configured to control the power voltage of the second circuit to be identical to the reference voltage of the first circuit.

The first switch and the second switch may be connected in series to connect a node between the first top transistor and the first bottom transistor, and to connect a node between the second top transistor and the second bottom transistor.

The power voltage control circuit may be a DC-DC converter.

The power voltage control circuit may be configured to control the power voltage to be greater than or less than an input voltage of the power voltage control circuit.

The power voltage control circuit may be configured to operate in a buck mode when the input voltage is greater than the power voltage, and is configured to operate in a boost mode when the input voltage is less than the power voltage.

The power voltage control circuit may include an error amplifier configured to receive the reference voltage and configured to output a feedback voltage.

The power voltage control circuit may further include a sawtooth wave generator configured to generate a sawtooth wave, and a comparator configured to compare the feedback voltage with a voltage of the sawtooth wave and generate a pulse width modulation signal.

The power voltage control circuit may include at least one node to which each of a MOSFET, a diode, and an inductor is connected.

The power voltage control circuit may include a coupled inductor.

The power voltage control circuit may include a plurality of switching elements, and the power voltage control circuit may be configured to independently operate in one of a buck mode and a boost mode based on a combination of the plurality of switching elements.

The power voltage control circuit may include a switching element, and the switching element may be configured to be switched when an input voltage of the power voltage control circuit is less than the power voltage.

The power voltage control circuit may include at least one node to which an inductor and an N-type semiconductor transistor are connected.

One of a diode and a P-type semiconductor transistor may be further connected to the at least one node.

The voice coil motor may be configured to connect a node between the first top transistor and the first bottom transistor, and a node between the second top transistor and the second bottom transistor.

The first top transistor and the second top transistor may be directly connected to a node of the power voltage control circuit, and the first bottom transistor, the second bottom transistor, the third bottom transistor, and the fourth bottom transistor may be respectively directly connected to a ground.

The first top transistor and the second top transistor may be P-type semiconductor transistors, and the first bottom transistor, the second bottom transistor, the third bottom transistor, and the fourth bottom transistors may be respectively N-type semiconductor transistors.

A gate terminal of the first bottom transistor may be connected to a gate terminal and a drain terminal of the fourth bottom transistor, and a gate terminal of the second bottom transistor may be connected to a gate terminal and a drain terminal of the third bottom transistor.

A driver integrated circuit (IC) configured to drive a voice coil motor, the driver IC may include a driver including the voice coil motor driving circuit, a communication device configured to communicate with an external host; a sensor configured to obtain position information of a lens in a camera module; a controller configured to generate a signal to drive the lens based on the position information of the lens and a command input from the external host to control the driver; and a power device configured to generate power to perform an operation.

The driver further may further include a plurality of channels, and the voice coil motor driving circuit may be selectively connected to any one of the plurality of channels.

Other features and aspects will be apparent from the following detailed description, the drawings, and the claims.

### BRIEF DESCRIPTION OF DRAWINGS

FIG. 1 illustrates an internal configuration of an example driver IC for driving a voice coil motor, in accordance with one or more embodiments.

FIG. 2 illustrates a circuit for driving a voice coil motor, in accordance with one or more embodiments.

FIG. 3 illustrates a power voltage control circuit and a circuit in which first and second switches of a first circuit are omitted from the circuit of FIG. 2.

FIG. 4 illustrates an equivalent circuit when among the third and fourth switches, the third switch is turned on and the fourth switch is turned off in the circuit of FIG. 3.

FIG. 5 illustrates a graph comparing power consumption of each of the circuit of FIG. 2 and the circuit of FIG. 3.

FIG. 6 is a graph illustrating a maximum value Iₘₐₓ of a driving current when a power voltage VM is fixed to 3.3 V.

FIG. 7 is a graph illustrating a maximum value Iₘₐₓ of a driving current when a power voltage VM is variable between 3.3 V and 5 V.

FIG. 8 is a graph illustrating a maximum value Iₘₐₓ of a driving current when the power voltage VM is variable between 0 V and 5 V.

FIG. 9 is a circuit view illustrating an example embodiment of a power voltage control circuit included in a circuit for driving a voice coil motor, in accordance with one or more embodiments.

FIG. 10A to FIG. 10E are graphs illustrating simulation results for the circuit of FIG. 9;

FIG. 11 is a circuit view illustrating a modified example of the power voltage control circuit of FIG. 9.

FIG. 12A and FIG. 12B are views illustrating a current flow when an input voltage Vᵢₙ of the circuit of FIG. 11 is higher than a power voltage VM.

FIG. 13A and FIG. 13B are views illustrating a current flow when an input voltage Vᵢₙ of the circuit of FIG. 11 is lower than a power voltage VM.

FIG. 14A to FIG. 14F are graphs illustrating simulation results for the circuit of FIG. 11.

FIG. 15 is a circuit view illustrating another modified example of the power voltage control circuit of FIG. 9.

FIG. 16A to FIG. 16E are graphs illustrating simulation results for the circuit of FIG. 15.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

One or more examples may provide a circuit for driving a voice coil motor having reduced offset characteristics by minimizing a channel length modulation effect.

One or more examples may provide a circuit for driving a voice coil motor having improved power efficiency.

One or more examples may provide a circuit for driving a voice coil motor in which a maximum value of a driving current may be increased to secure a large driving force.

In accordance with the one or more examples, a circuit for driving a voice coil motor may minimize a channel length modulation effect, thereby reducing offset characteristics.

In accordance with the one or more examples, power efficiency may be improved, and a maximum value of driving a current may be increased, thereby providing greater driving power to the voice coil motor.

The present disclosure relates to a circuit for driving a voice coil motor and a driver IC for driving a voice coil motor, and a circuit for driving a voice coil motor according to an example embodiment of the present disclosure is capable of variable control of a power voltage and may be included as a component of the driver IC for driving a voice coil motor.

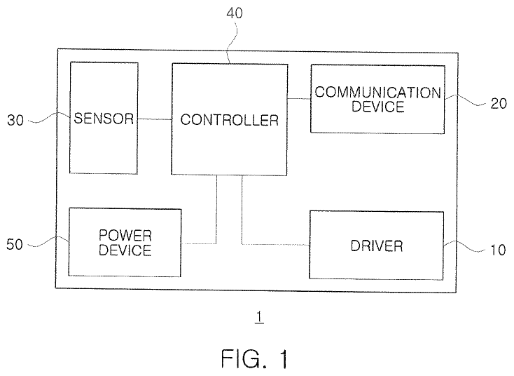

FIG. 1 is a view schematically illustrating an internal configuration of a driver IC that drives a voice coil motor.

Referring to FIG. 1, a driver IC 1 for driving a voice coil motor, in accordance with one or more embodiments, may include a driver 10, a communication device 20, a sensor 30, a controller 40, and a power device 50. The controller 40 may be connected to each of the driver 10, the communication device 20, the sensor 30, and the power device 50.

The driver 10 may be configured to include a circuit 100 that drives a voice coil motor to be described below, and may drive a lens within a camera module using a voice coil motor according to the control of the controller 40.

Additionally, the driver 10 may include a plurality of channels, and the circuit 100 for driving a voice coil motor may be selectively connected to one of the plurality of channels. Accordingly, when a driver IC for driving a voice coil motor drives the voice coil motor using a plurality of channels, the circuit 100 for driving a voice coil motor, in accordance with one or more embodiments, may be connected only to a channel that utilizes variable control of the power voltage. However, the one or more examples are not limited thereto.

The communication device 20 is configured to communicate with an external host. The communication device 20 may use, for example, a communication protocol such as Inter-Integrated Circuit (I2C), Improved Inter-Integrated Circuit (I3C), Serial Peripheral Interface (SPI), Universal Asynchronous Receiver/Transmitter (UART). However, the one or more examples are not limited thereto.

The sensor 30 may be configured to obtain position information of a lens in a camera module, and may receive the position information of the lens measured from a Hall sensor.

The controller 40 may generate a signal for driving the lens according to the position information of the lens obtained through the sensor 30 and a command input from the external host through the communication device 20, thereby controlling the driver 10.

The power device 50 may generate and supply power for operations of each component included in the driver IC for driving a voice coil motor.

The circuit 100 for driving a voice coil motor according to an example embodiment of the present disclosure may be included in the driver 10 of the driver IC 1 for driving a voice coil motor described above, or may be a component selectively connected to the driver 10, and the configuration and operation of the circuit 100 for driving a voice coil motor, in accordance with one or more embodiments, will be described in detail below with reference to the attached drawings.

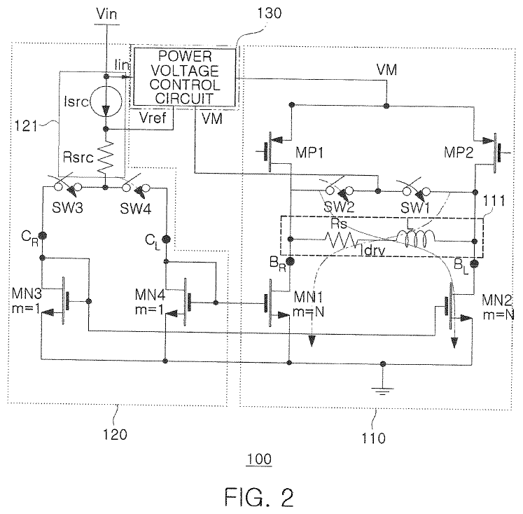

Referring to FIG. 2, a circuit 100 for driving a voice coil motor, in accordance with one or more embodiments, may include a first circuit 110, and a second circuit 120 connected to the first circuit 110, and may include a power voltage control circuit 130 connected to each of the first circuit 110 and the second circuit 120. In an example, the first circuit 110 and the second circuit 120 may be implemented as semiconductor integrated circuits and may share a power voltage VM and a ground.

In the first circuit 110, a first top transistor MP1 and a second top transistor MP2, and a first bottom transistor MN1 and a second bottom transistor MN2 may be connected by a bridge structure, and the first circuit 110 may include a first switch SW1 and a second switch SW2, and a voice coil motor 111.

The second circuit 120 may include a third bottom transistor MN3 and a fourth bottom transistor MN4, and a current source I_{src}, and may further include a third switch SW3 and a fourth switch SW4.

The power voltage control circuit 130 may be connected to the first circuit 110 and the second circuit 120, respectively, and may control the power voltage VM of the second circuit 120 to match a reference voltage V_{ref} of the first circuit 110 through a feedback operation. Preferably, the power voltage control circuit 130 may control the power voltage VM of the second circuit 120 to be identical to the reference voltage V_{ref} of the first circuit 110. In the one or more examples, the disclosure that the power voltage VM of the second circuit 120 is identical to the reference voltage V_{ref} of the first circuit may be defined to include not only an example in which they are exactly identical, but also an example in which they are substantially identical. The meaning of being substantially identical may denote that a difference between the reference voltage V_{ref} of the first circuit and the power voltage VM of the second circuit is negligibly small, including manufacturing errors or measurement errors. For example, the meaning thereof may denote that the power voltage VM of the second circuit has a difference of ±0.1% or less as compared to the reference voltage V_{ref} of the first circuit, but the one or more examples are not limited thereto.

In the first circuit 110, the first switch SW1 and the second switch SW2 may be connected in series to connect a node between the first top transistor MP1 and the first bottom transistor MN1, and to connect a node between the second top transistor MP2 and the second bottom transistor MN2.

The bridge structure included in the first circuit 110 may correspond to, for example, one of an H-bridge, a half-bridge, and a full-bridge, and may vary depending on the design of the circuit 100 for driving a voice coil motor. There-among, the H-bridge may be an efficient structure for precise bidirectional driving of the voice coil motor.

The first top transistor MP1 and the second top transistor MP2 may be directly connected to a node of the power voltage VM, and may be P-type semiconductor transistors. Additionally, the first to fourth bottom transistors MN1, MN2, MN3 and MN4 may be directly connected to the ground, and may be N-type semiconductor transistors. However, the one or more examples are not limited thereto, and a N-type/P-type relationship of the transistors may be implemented opposite to the N-type/P-type relationship illustrated in FIG. 2 depending on the circuit design.

A gate terminal of the first bottom transistor MN1 may be connected to a gate terminal and a drain terminal of the fourth bottom transistor MN4. The first bottom transistor MN1 and the fourth bottom transistor MN4 may share a voltage of the gate terminal, and thus may have a current-mirror relationship.

Additionally, a gate terminal of the second bottom transistor MN2 may be connected to a gate terminal and a drain terminal of the third bottom transistor MN3. The second bottom transistor MN2 and the third bottom transistor MN3 may share the voltage of the gate terminal and thus may have a current-mirror relationship.

The first and second top transistors MP1 and MP2 and the first and second bottom transistors MN1 and MN2 may perform a switching operation of controlling a direction of a driving current I_{drv} flowing to the voice coil motor 111.

In an example, when a gate voltage of the second top transistor MP2 is lower than a gate voltage of the first top transistor MP1, a driving current I_{drv} flowing through the voice coil motor 111 may be generated along a path indicated by a dashed line in FIG. 2, and in this example, the first switch SW1 of the first circuit 110 and the fourth switch SW4 of the second circuit 120 may operate to be switched on.

Conversely, when the gate voltage of the second top transistor MP2 is higher than the gate voltage of the first top transistor MP1, a driving current I_{drv} flowing through the voice coil motor 111 may be generated along the path indicated by a solid line in FIG. 2, and in this example, the second switch SW2 of the first circuit 110 and a third switch SW3 of the second circuit 120 may operate to be switched on.

The voice coil motor 111 may connect a node between the first top transistor MP1 and the first bottom transistor MN1, and connect a node between the second top transistor MP2 and the second bottom transistor MN2.

The power voltage control circuit 130 may be connected to a node between the first switch SW1 and the second switch SW2 of the first circuit 110.

The power voltage control circuit 130 may control the power voltage VM applied to a side of the first circuit 110 to be higher than or lower than an input voltage Vᵢₙ applied to a side of the second circuit 120. The power voltage control circuit 130 of an example embodiment may correspond to a DC-DC converter, and may operate in a buck mode when the input voltage Vᵢₙ is higher than the power voltage VM, and may operate in a boost mode when the input voltage Vᵢₙ is lower than the power voltage VM. However, the one or more examples are not limited thereto, and the power voltage control circuit 130 may operate in only one of the buck mode and the boost mode.

Referring to FIG. 2, the power voltage control circuit 130, in accordance with one or more embodiments, may control a voltage V_{CR} of a node C_{R} and a voltage V_{BL} of a node B_{L} to be identical in order to minimize a current error due to a channel length modulation phenomenon in a current-mirror process, and may control a voltage V_{CL} of the node C_{L} and a voltage V_{BR} of the node B_{R} to be identical. In an example, the meaning of the voltage being identical may be defined to include not only an example in which they are exactly identical, but also an example in which they are substantially identical. The meaning of being substantially identical may denote an example in which a difference from a comparison voltage is within ±0.1%, including manufacturing errors or measurement errors, but the one or more examples are not limited thereto.

The following mathematical expression explains the current error reduction effect according to the control of the power voltage VM of the power voltage control circuit 130. This will be explained based on the voltage V_{CR} of the node C_{R} and the voltage V_{BL} of the node B_{L}, and may be applied to the voltage V_{CL} of the node C_{L} and the voltage V_{BR} of the node B_{R}.

$${V}_{ref} = {I}_{src} \times {R}_{src} + {V}_{CR} \qquad [ Mathematical Expression 1 ]$$

$${V}_{BL} = V M - {I}_{drv} \times {R}_{s} \qquad [ Mathematical Expression 2 ]$$

In an example, since the reference voltage V_{ref} is controlled to be identical to the power voltage VM by a feedback operation of the power voltage control circuit 130,

$${V}_{BL} = {I}_{src} \times {R}_{src} + {V}_{CR} - {I}_{drv} \times {R}_{s} \qquad [ Mathematical Expression 3 ]$$

In an example, if I_{drv}=N*I_{src} and R_{src}:Rₛ=N:1,

$${V}_{BL} = \frac{{I}_{drv}}{N} \times N \times {R}_{s} + {V}_{CR} - {I}_{drv} \times {R}_{s} = {V}_{CR} \qquad [ Mathematical Expression 4 ]$$

As a result, the voltage V_{CR} of the node C_{R} is controlled to be identical to the voltage V_{BL} of the node B_{L}, so that the V_{DS} of the third bottom transistor MN3 and the second bottom transistor MN2 are identical, and thus the current error due to the channel length modulation effect may be eliminated.

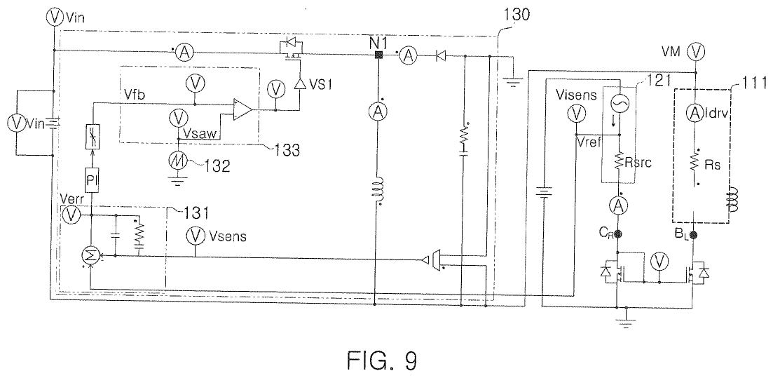

The detailed configuration and various example embodiments of the power voltage control circuit 130 will be described below with reference to FIGS. 9 to 16. Hereinafter, the current error, power consumption, and a maximum value Iₘₐₓ of a driving current, which may occur in the example in which the power voltage control circuit 130 and the first and second switches SW1 and SW2 are omitted in the circuit 100 for driving a voice coil motor, in accordance with one or more embodiments, will be described in detail in comparison with the circuit 100 for driving a voice coil motor, in accordance with one or more embodiments.

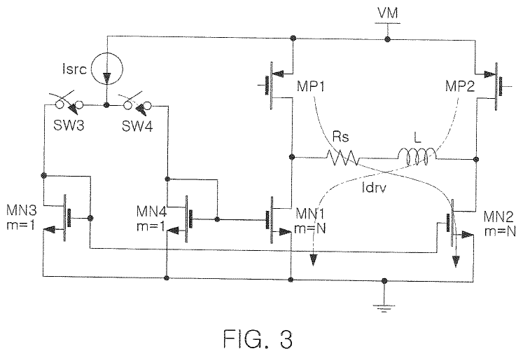

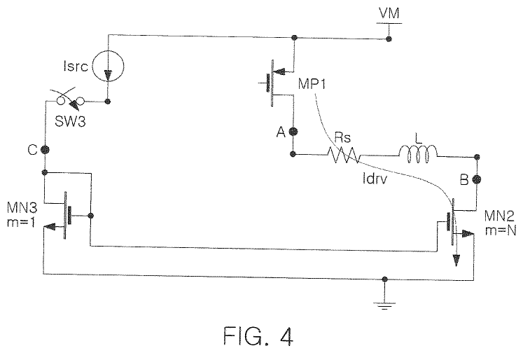

FIG. 3 illustrates a power voltage control circuit and a circuit in which first and second switches of a first circuit are omitted from the circuit of FIG. 2. FIG. 4 illustrates an equivalent circuit when among the third and fourth switches, the third switch is turned on and the fourth switch is turned off in the circuit of FIG. 3.

Referring to FIG. 3, a size ratio of the third bottom transistor MN3 and the second bottom transistor MN2, and a size ratio of the fourth bottom transistor MN4 and the first bottom transistor MN1 may be set to 1:N, respectively. In this example, a driving current I_{drv} flowing through a coil L should be N*I_{src}, but due to the channel length modulation phenomenon, a driving current of I_{drv} of N*I_{src}+N*I_{src}*λ*(V_{DS}−V_{DS,sat}) flows through the coil L, which may be treated as a current error.

$${I}_{D} = \frac{{KP}_{n}}{2} \cdot \frac{W}{L} {( {V}_{GS} - {V}_{THN} )}^{2} \cdot [ 1 + λ ( {V}_{DS} - {V}_{DS , sat} ) ] = {I}_{D , sat} \cdot [ 1 + λ ( {V}_{DS} - {V}_{DS , sat} ) ] \qquad [ Mathematical Expression 5 ]$$

(where KPₙ:μₙCₒₓ, W: channel width, L: channel length, V_{THN}: threshold voltage, and λ: channel length modulation coefficient).

This current error is treated as an offset voltage V_{offset} by multiplying a certain resistance, and may be a factor that deteriorates the characteristics, such as generating noise during actuator driving control or making precise control difficult.

In FIG. 3, when a gate voltage of the first top transistor MP1 is lower than a gate voltage of the second top transistor MP2 and the third switch SW3 operates to be switched on and the fourth switch SW4 operates to be switched off, the driving current I_{drv} flows in a solid line direction, and the equivalent circuit in this case is illustrated in FIG. 4.

Referring to FIG. 4, a voltage of a node B connected to the second bottom transistor MN2 and a voltage of a node C connected to the third bottom transistor MN3 have different voltages due to resistance Rₛ of the voice coil motor and resistance R_{MP1} of the first top transistor MP1, and a size ratio of the third bottom transistor MN3 and the second bottom transistor MN2, which is 1:N. Ultimately, due to the channel length modulation phenomenon described above, the driving current I_{drv} flowing through the coil L is not equal to N*I_{src}.

$${V}_{B} = V M - \{ {I}_{drv} \times ( {R}_{s} + {R}_{MP 1} ) \} \neq {V}_{C} \qquad [ Mathematical Expression 6 ]$$

The circuit 100 for driving a voice coil motor, in accordance with one or more embodiments, may control a voltage V_{B} of the node B and a voltage V_{C} of the node C to be identical to each other through the power voltage control circuit 130 to reduce a current error, i.e., the offset voltage V_{offset}, so that noise may be reduced when driving the actuator, and the driving accuracy may be improved.

Referring to FIG. 5, the power efficiency improvement effect of the circuit 100 for driving a voice coil motor, in accordance with one or more embodiments, will be described.

FIG. 5 is a graph comparing power consumption of each of the circuit of FIG. 2 and the circuit of FIG. 3, respectively.

In the example of the circuit of FIG. 2 to which the circuit 100 for driving a voice coil motor, in accordance with one or more embodiments, is applied, the power consumed is as follows.

$${P}_{in} = {I}_{in} \times {V}_{in , eff} = \frac{V M \times {I}_{drv}}{{V}_{in} \times {I}_{in}} \qquad [ Mathematical Expression 7 ]$$

$${I}_{in} = \frac{V M \times {I}_{drv}}{{V}_{in} \times eff} \qquad [ Mathematical Expression 8 ]$$

$${P}_{in} = \frac{V M \times {I}_{drv} \times {V}_{in}}{{V}_{in} \times eff} = {I}_{drv} \times V M \times \frac{1}{eff} = {I}_{drv} \times [ {V}_{C} + {I}_{drv} \times {R}_{s} ] \times \frac{1}{eff} = ( {{I}_{drv}}^{2} \times {R}_{s} + {I}_{drv} \times {V}_{C} ) \times \frac{1}{eff} \qquad [ Mathematical Expression 9 ]$$

When the results are expressed as a graph of power consumption Pᵢₙ against driving current I_{drv}, this may be a graph along triangular points of FIG. 5 (assuming Rₛ=20, eff=1 and V_{C}=1).

In the example of a power consumption Pᵢₙ graph for the circuit of FIG. 3 along circular points in FIG. 5, since the power voltage VM is fixed at 2.8 V or 3.3 V and the input current and output current are identical to each other, the power consumption Pᵢₙ is linearly proportional to the driving current I_{drv}.

Accordingly, comparing the two graphs of FIG. 5, it may be seen that when the circuit 100 for driving a voice coil motor, in accordance with one or more embodiments, is applied (see the circuit of FIG. 2), the power consumption Pᵢₙ against the driving current I_{drv} is reduced, thereby improving power efficiency.

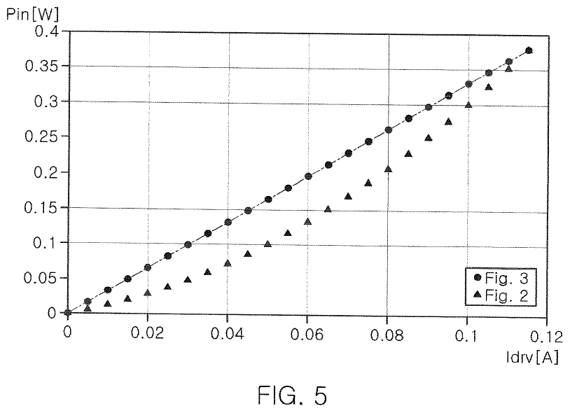

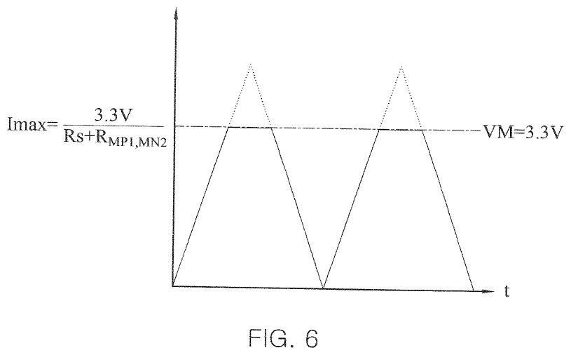

Referring to FIGS. 6 to 8, the effect of improving the maximum value Iₘₐₓ of the driving current for increasing the driving power of the actuator will be described.

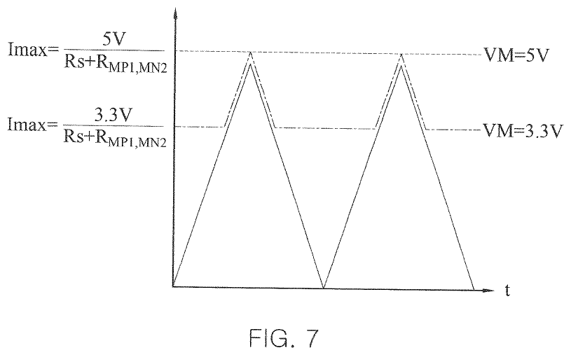

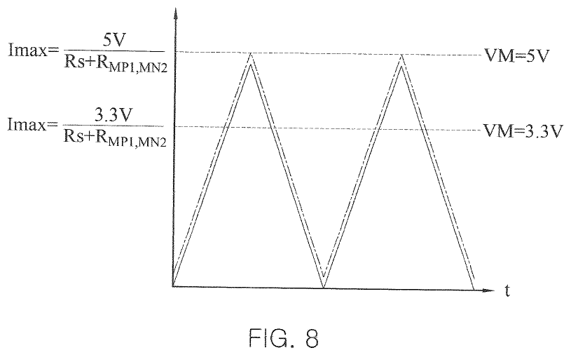

FIG. 6 is a graph illustrating a maximum value Iₘₐₓ of a driving current when a power voltage VM is fixed to 3.3 V. FIG. 7 is a graph illustrating a maximum value Iₘₐₓ of a driving current when a power voltage VM is variable between 3.3 V and 5 V. FIG. 8 is a graph illustrating a maximum value Iₘₐₓ of a driving current when the power voltage VM is variable between 0 V and 5 V.

Referring to FIG. 6, in the example in which there is no power voltage control circuit 130 like the circuit of FIG. 3, the power voltage VM may generally be set to a fixed voltage between 2.8 V and 3.3 V, and FIG. 6 illustrates an example in which the power voltage VM is fixed to 3.3 V.

In this example, the maximum value Iₘₐₓ of the driving current may be expressed as follows.

$${I}_{max} = \frac{V M}{{R}_{s} + {R}_{MP 1 , MN 2}} \qquad [ Mathematical Expression 10 ]$$

Since the driving power of the voice coil motor used in a camera actuator is proportional to the driving current I_{drv}, as the lens becomes heavier, a method to increase the maximum value Iₘₐₓ of the driving current is desirous.

According to the [Mathematical Expression 6] described above, it is desirous to minimize the resistance components of the coil and switching elements in the circuit. However, in order to reduce the resistance components, the size of the coil and switching elements, and the like, should be changed. As an alternative thereto, in the example of the circuit 100 for driving a voice coil motor, in accordance with one or more embodiments, the maximum value Iₘₐₓ characteristics of the driving current may be improved by controlling the power voltage VM.

In the example of FIG. 6, since the power voltage VM is fixed to 3.3 V, the maximum value Iₘₐₓ of the driving current becomes 3.3 V/(Rₛ+R_{MP1,MN2}).

In the example of FIG. 7, the circuit 100 for driving a voice coil motor, in accordance with one or more embodiments, may variably control the power voltage VM between 3.3 V and 5 V through the power voltage control circuit 130, so that the power voltage VM increases together with the increase in the driving current I_{drv}, and the maximum value Iₘₐₓ of the driving current may be increased to 5 V/(Rₛ+R_{MP1,MN2}).

In the example of FIG. 8, the circuit 100 for driving a voice coil motor, in accordance with one or more embodiments, may vary the power voltage VM through the power voltage control circuit 130 not only when the driving current I_{drv} increases but also when the driving current I_{drv} decreases, and in this example, the efficiency of the power consumed in the driving circuit may be improved.

Hereinafter, with reference to FIGS. 9 to 17, various example embodiments and detailed components of the power voltage control circuit 130 included in the circuit 100 for driving a voice coil motor, in accordance with one or more embodiments, will be described.

FIG. 9 is a circuit view illustrating an example embodiment of a power voltage control circuit included in a circuit for driving a voice coil motor.

Referring to FIG. 9, an example circuit for driving a voice coil motor may include a power voltage control circuit 130, and the power voltage control circuit 130 may include an error amplifier 131 configured to receive a reference voltage V_{ref} and to output a feedback voltage V_{fb}.

Additionally, the power voltage control circuit 130 may further include a sawtooth wave generator 132 that generates a sawtooth wave, and a comparator 133 that compares the feedback voltage V_{fb} and a voltage V_{saw} of the sawtooth wave to generate a pulse width modulation (PWM) signal.

Additionally, the power voltage control circuit 130 may include at least one node N1 to which each of a MOSFET, a diode, and an inductor is connected.

The power voltage control circuit 130 of FIG. 9 may control the power voltage VM to be high or low, and may perform feedback control so that a reference current I_{src} of a current source 121 is monitored, and input to the error amplifier 131, and the power voltage VM follows reference current I_{src}. More specifically, the power voltage VM and the reference voltage V_{ref} that follows the reference current I_{src} may be compared with each other, and to compensate for a result of the comparison, the feedback voltage V_{fb} and the sawtooth voltage V_{saw} may be compared to generate a pulse width modulation signal V_{S1}, from which an operation of increasing or decreasing the power voltage VM may be performed. In an example, a resistance component R_{src} of the current source 121 and the resistance component Rₛ of the voice coil motor 111 may be set to be identical to each other considering the current ratio, and as a result, since the reference voltage V_{ref} and the power voltage VM are controlled to be identical, a voltage of the node C_{R} and a voltage of the node B_{L} may be controlled to be identical, so that a current error due to channel length modulation, i.e., the occurrence of the offset voltage V_{offset}, may be minimized.

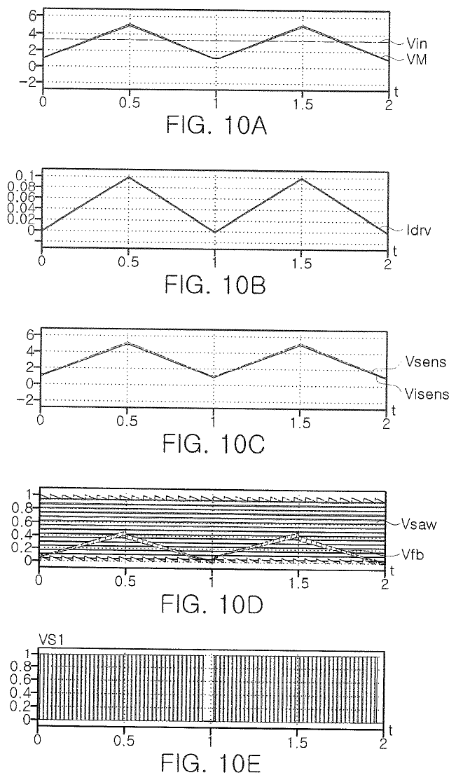

FIGS. 10A to 10E are graphs illustrating simulation results for the circuit of FIG. 9.

Referring to FIG. 10A and FIG. 10B, it may be confirmed that the power voltage VM is controlled in proportion to a magnitude of the driving current I_{drv}. In order to perform such negative feedback operation, as in FIG. 10D, the sawtooth voltage V_{saw} and the feedback voltage V_{fb}, which is an output voltage of the error amplifier 131, may be compared to generate a pulse width modulation signal V_{S1} as in FIG. 10E. As a result, as in FIG. 10C, a sensing voltage Vᵢₛₑₙₛ of the driving current I_{drv} and the sensing voltage Vₛₑₙₛ of the power voltage VM may be controlled identically.

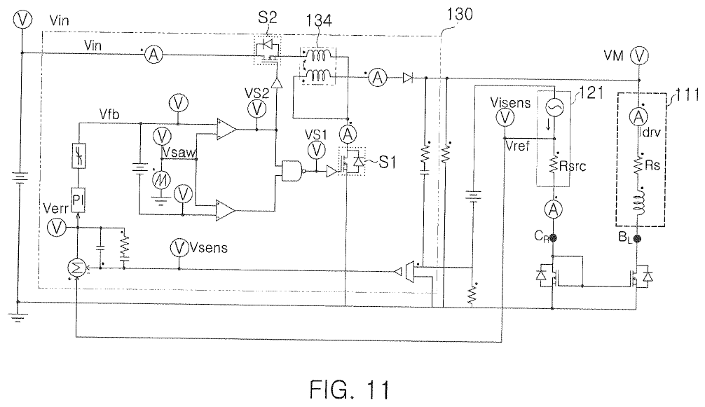

FIG. 11 is a circuit view illustrating a modified example of the power voltage control circuit of FIG. 9.

The circuit of FIG. 11 may have a similar operation to the circuit of FIG. 9 in that the circuit of FIG. 11 may control the increase and decrease of the power voltage VM. However, unlike FIG. 9, the circuit of FIG. 11 is connected to only one ground, which may be more advantageous in terms of noise reduction.

Referring to FIG. 11, the example power voltage control circuit 130 may include a coupled inductor 134.

Additionally, the example power voltage control circuit 130 may include a plurality of switching elements S1 and S2, and may independently operate in either a buck mode or a boost mode depending on a combination of the switching elements S1 and S2.

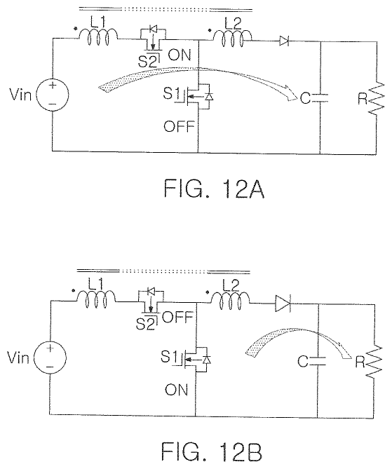

FIGS. 12A and 12B are views illustrating a current flow when an input voltage Vᵢₙ of the circuit of FIG. 11 is higher than a power voltage VM. That is, this may correspond to a buck mode operation for decreasing the input voltage Vᵢₙ.

Referring to FIG. 12A, when the input voltage Vᵢₙ is higher than the power voltage VM, the second switching element S2 may operate to be switched on and the first switching element S1 may operate to be switched off, thereby charging energy to inductors L1 and L2 and supplying current to the load at the same time.

Next, referring to FIG. 12B, the second switching element S2 may operate to be switched off and the first switching element S1 may operate to be switched on, so that the energy charged in the inductor may be transferred to the load.

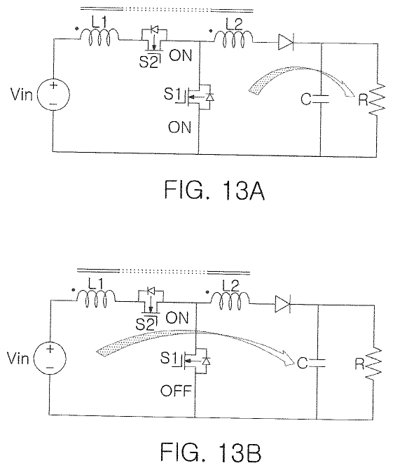

FIGS. 13A and 13B are views illustrating a current flow when an input voltage Vᵢₙ of the circuit of FIG. 11 is lower than a power voltage VM. In other words, this may correspond to a boost mode operation for increasing the input voltage Vᵢₙ.

Referring to FIG. 13A and FIG. 13B, when the input voltage Vᵢₙ is lower than the power voltage VM, the second switching element S2 may always operate to be switched on, and only the first switching element S1 may perform a switching operation on or off. When the first switching element S1 operates to be switched on, energy may be charged in the inductors L1 and L2, and when the first switching element S1 operates to be switched off, the energy charged in the inductors L1 and L2 may be transferred to the load.

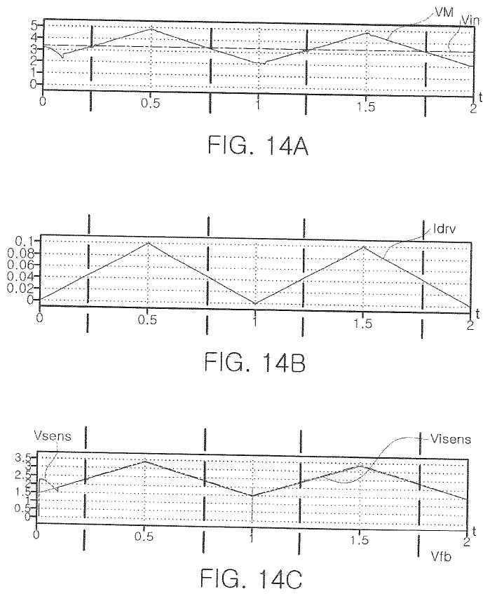

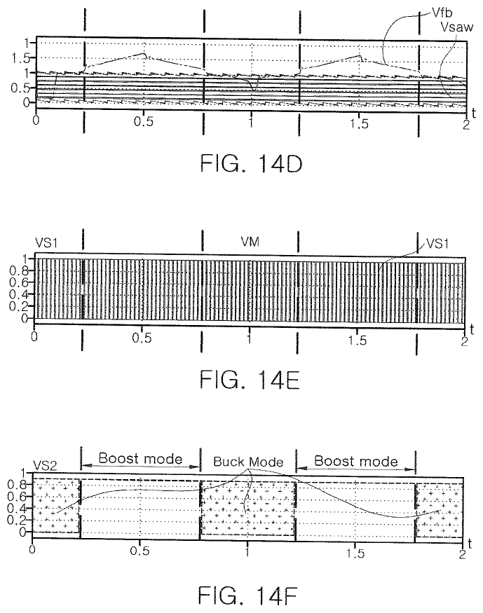

FIGS. 14A to 14F are graphs illustrating simulation results for the circuit of FIG. 11.

Referring to FIG. 14A, FIG. 14E and FIG. 14F, the first switching element S1 always performs a switching operation depending on the magnitude of the input voltage Vᵢₙ and the power voltage VM, but the second switching element S2 performs a switching operation only in the buck mode. As a result, as illustrated in FIG. 14C, it may be confirmed that the sensing voltage Vᵢₛₑₙₛ of the driving current I_{drv} and the sensing voltage Vₛₑₙₛ of the power voltage VM are controlled identically. That is, as illustrated in FIG. 14A and FIG. 14B, it may be confirmed that the power voltage VM is variably controlled in proportion to the magnitude of the driving current I_{drv}.

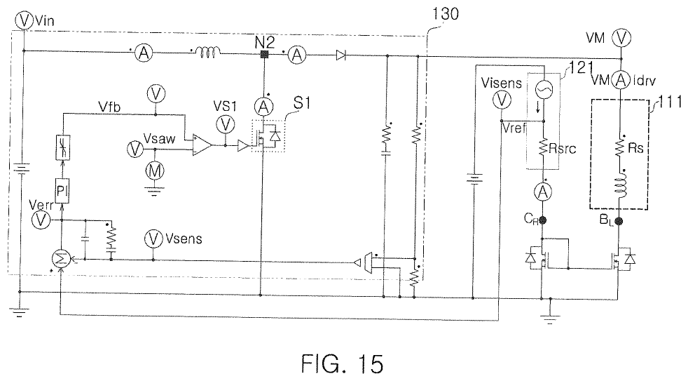

FIG. 15 is a circuit view illustrating another modified example of the power voltage control circuit of FIG. 9.

The circuit of FIG. 15 is a circuit that controls the power voltage VM to increase, i.e., the boost mode operation. The power voltage control circuit 130 of an example embodiment is a circuit that may be used when a maximum value Iₘₐₓ of the driving current is limited by the power voltage VM and a relatively high power voltage VM is desired. For example, when a mechanical jam occurs in the camera actuator and a large load is applied momentarily, this may be used for the purpose of increasing the maximum value Iₘₐₓ of the driving current, but the present disclosure is not limited thereto.

Referring to FIG. 15, the example power voltage control circuit 130 may include one switching element S1, and the switching element S1 may perform a switching operation when the input voltage Vᵢₙ of the power voltage control circuit 130 is lower than the power voltage VM.

Additionally, the example power voltage control circuit 130 of an example embodiment may include at least one node N2 to which an inductor and an N-type semiconductor transistor are connected, and either a diode or a P-type semiconductor transistor may be further connected to the node N2.

For example, the example switching element S1 may be an N-type semiconductor transistor, and the element connected to the N2 node is illustrated as a diode, but is not limited thereto, and may also be implemented as a P-type semiconductor transistor. The example power voltage control circuit 130 does not perform a switching operation under the condition that the input voltage Vᵢₙ is higher than the power voltage VM, and in this case, efficiency degradation due to voltage drop in the diode may occur, but if the diode is replaced with a P-type semiconductor transistor, this may be advantageous in terms of power efficiency.

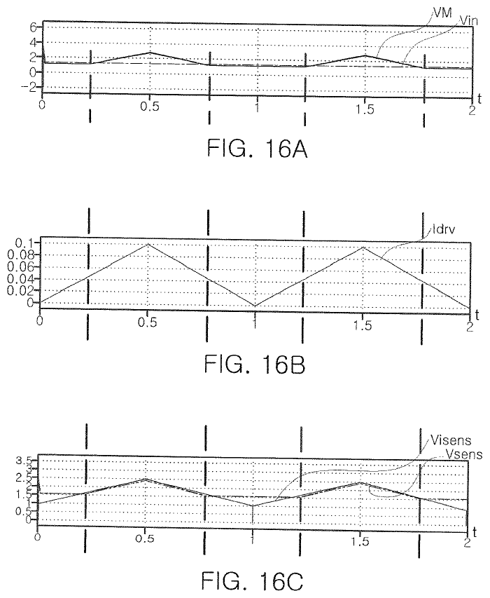

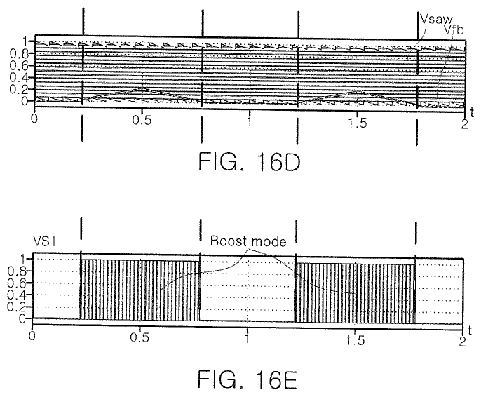

FIGS. 16A to 16E are graphs illustrating simulation results for the circuit of FIG. 15.

Referring to FIG. 16A and FIG. 16E, a switching operation for the boost mode is performed only when the input voltage Vᵢₙ is lower than the power voltage VM, and as a result, in the boost mode, as illustrated in FIG. 16C, the sensing voltage Vᵢₛₑₙₛ of the driving current I_{drv} and the sensing voltage Vₛₑₙₛ of the power voltage VM may be controlled to be identical.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A voice coil motor driving circuit, comprising:
a first circuit in which a first top transistor, a second top transistor, a first bottom transistor, and a second bottom transistor are connected to each other by a bridge structure, and the first circuit further comprises a first switch, a second switch, and a voice coil motor;
a second circuit comprising a third bottom transistor, a fourth bottom transistor, and a current source; and
a power voltage control circuit respectively connected to the first circuit and the second circuit, and configured to control a power voltage of the second circuit to match a reference voltage of the first circuit based on a feedback operation,
wherein the power voltage control circuit is connected to a node between the first switch and the second switch.

2. The circuit according to claim 1, wherein the power voltage control circuit is configured to control the power voltage of the second circuit to be identical to the reference voltage of the first circuit.

3. The circuit according to claim 1, wherein the first switch and the second switch are connected in series to connect a node between the first top transistor and the first bottom transistor, and to connect a node between the second top transistor and the second bottom transistor.

4. The circuit according to claim 1, wherein the power voltage control circuit is a DC-DC converter.

5. The circuit according to claim 1, wherein the power voltage control circuit is configured to control the power voltage to be greater than or less than an input voltage of the power voltage control circuit.

6. The circuit according to claim 5, wherein the power voltage control circuit is configured to operate in a buck mode when the input voltage is greater than the power voltage, and is configured to operate in a boost mode when the input voltage is less than the power voltage.

7. The circuit according to claim 1, wherein the power voltage control circuit comprises an error amplifier configured to receive the reference voltage and configured to output a feedback voltage.

8. The circuit according to claim 7, wherein the power voltage control circuit further comprises a sawtooth wave generator configured to generate a sawtooth wave, and a comparator configured to compare the feedback voltage with a voltage of the sawtooth wave and generate a pulse width modulation signal.

9. The circuit according to claim 1, wherein the power voltage control circuit comprises at least one node to which each of a MOSFET, a diode, and an inductor is connected.

10. The circuit according to claim 1, wherein the power voltage control circuit comprises a coupled inductor.

11. The circuit according to claim 10, wherein the power voltage control circuit comprises a plurality of switching elements, and the power voltage control circuit is configured to independently operate in one of a buck mode and a boost mode based on a combination of the plurality of switching elements.

12. The circuit according to claim 1, wherein the power voltage control circuit comprises a switching element, and the switching element is configured to be switched when an input voltage of the power voltage control circuit is less than the power voltage.

13. The circuit according to claim 12, wherein the power voltage control circuit comprises at least one node to which an inductor and an N-type semiconductor transistor are connected.

14. The circuit according to claim 13, wherein one of a diode and a P-type semiconductor transistor is further connected to the at least one node.

15. The circuit according to claim 1, wherein the voice coil motor is configured to connect a node between the first top transistor and the first bottom transistor, and a node between the second top transistor and the second bottom transistor.

16. The circuit according to claim 1, wherein the first top transistor and the second top transistor are directly connected to a node of the power voltage control circuit, and
the first bottom transistor, the second bottom transistor, the third bottom transistor, and the fourth bottom transistor are respectively directly connected to a ground.

17. The circuit according to claim 1, wherein the first top transistor and the second top transistor are P-type semiconductor transistors, and
the first bottom transistor, the second bottom transistor, the third bottom transistor, and the fourth bottom transistors are respectively N-type semiconductor transistors.

18. The circuit according to claim 17, wherein a gate terminal of the first bottom transistor is connected to a gate terminal and a drain terminal of the fourth bottom transistor, and
a gate terminal of the second bottom transistor is connected to a gate terminal and a drain terminal of the third bottom transistor.

19. A driver integrated circuit (IC) configured to drive a voice coil motor, the driver IC comprising:
a driver comprising the voice coil motor driving circuit of claim 1;
a communication device configured to communicate with an external host;
a sensor configured to obtain position information of a lens in a camera module;
a controller configured to generate a signal to drive the lens based on the position information of the lens and a command input from the external host to control the driver; and
a power device configured to generate power to perform an operation.

20. The driver IC according to claim 19, wherein the driver further comprises a plurality of channels, and the voice coil motor driving circuit is selectively connected to any one of the plurality of channels.
